(19) United States
(12) Patent Application Publication
(10) Pub. No.: US 2026/0259001 A1
(43) Pub. Date: Sep. 3, 2026

(54) Method and apparatus for heating air containing solids

(71) Applicant: Rinheat Oy, Espoo (FI)

(72) Inventors: Arvi Artamo, Espoo (FI); Pentti Juhola, Espoo (FI)

(21) Appl. No.: 18/873,357

(22) PCT Filed: May 31, 2023
(86) PCT No.: PCT/FI2023/050306

§ 371 Date: Dec. 10, 2024

(30) Foreign Application Priority Data
Jun. 22, 2022 (FI) 20225564

(51) Int. Cl. F26B 3/10; F26B 15/20; F26B 17/12

(52) U.S. Cl. CPC F26B 3/10; F26B 15/20; F26B 17/12

(57) ABSTRACT

According to an example aspect of the present invention, there is provided a vertical tubular heat exchanger having a tube side and a shell side and comprising a shell, an upper tube sheet, a lower tube sheet, a plurality of straight tubes, an upper head and a lower head. The shell side of the heat exchanger is divided into two or more separate shell side chambers by one or more intermediate tube sheets. According to another aspect of the present invention there is also provided a system comprising a tubular heat exchanger, wherein a first steam source is connected to the chamber located closer to the upper head and a second steam source is connected to the chamber located closer to the lower head.

### FIELD

The present invention relates to a pneumatic dryer. In particular, the invention relates to a pneumatic dryer for heating air containing solids and a method for heating air containing solids.

### BACKGROUND

In a pneumatic dryer, the drying air brings in the thermal energy needed to dry the solids particles, removes the generated water vapor, and transports the solids particles through the dryer. To achieve a sufficiently low final moisture content of the solids particles, two or three pneumatic dryers are often connected in series. Dried solids are often cooled by a pneumatic cooling step using cooler transport air after the final drying step. The main components of a pneumatic dryer are: an air blower, an air heater, a solids particle feeder, a drying duct and a solids separator, e.g. a cyclone. Exhaust air is often treated in a water scrubber to minimize solids emissions.

GB 2146346 A discloses an exemplary a vertical heat exchanging system. The system comprises three exchangers stacked on top of each other as modules, which are connected in series via double tube plates to provide three heating stages. The system is used as a falling film heat exchanger for heating a starch stream without boiling it. The first heating stage provided for by the top chamber produces a mild temperature rise with each stage providing a more intense temperature increase. The middle chamber and the lower chamber have steam inlets provided to the top half of the chamber.

To minimize heat loss, the amount of exhaust air must be kept to a minimum. One way to reduce the amount of exhaust air is to increase the temperature difference in the drying air. The maximum air temperature is limited by the heat resistance of the solid to be dried and the risk of fire.

Another possible method is the recycling and reheating of drying air. The heated recirculated air almost always contains small amounts of solid particles that can contaminate or clog the air heater. Vertical tubular heat exchangers are best suited for heating recirculated air, with recirculated air flowing in the tubes and steam condensing on the shell side. The problem with these air heaters is the accumulation of solid particles on the blind surfaces of the upper tube sheet and therefore they are usually provided with compressed air nozzles for cleaning. Since the temperature of the upper tube sheet is practically very close to the condensing temperature of the steam, a longer delay of the solids on the surface of the upper tube sheet can also cause discoloration of the product or other disadvantage due to the high temperature.

### SUMMARY

The aim of the invention is to improve heat economy and to reduce fan power.

The invention is defined by the features of the independent claims. Some specific embodiments are defined in the dependent claims.

According to a first aspect of the present disclosure, there is provided a vertical tubular heat exchanger for heating air containing solids. The heat exchanger has a tube side and a shell side and comprises a shell, an upper tube sheet, a lower tube sheet, a plurality of straight tubes, an upper head and a lower head. The shell side of the heat exchanger is divided into two or more separate shell side chambers by one intermediate tube sheet or more than one intermediate tube sheet. The tubes extend continuously between the upper tube sheet and the lower tube sheet. The shell side has connections for steam inlet, condensate outlet and inert gas outlet. The connections for steam inlet and condensate outlet are located in the lower part of the shell side chambers. The connection for inert gas outlet is located at the upper part of the shell side chambers.

According to a second aspect of the present disclosure, there is provided a system for heating air containing solids. The system has a heat exchanger as described above and a first steam source is to the chamber located closer to the upper head as well as a second steam source is connected to the chamber located closer to the lower head.

According to a third aspect of the present disclosure, there is provided a method for heating air containing solids. The method involves feeding process air, which contains moist solids into tubes of the heat exchanger and feeding steam to the two or more separate shell side chambers. The process air flows in the direction from the air inlet at top heat exchanger to the air outlet at the bottom of the heat exchanger.

Certain detailed embodiments may include one or more features from the following itemized list:
the upper ends of the tubes are provided with inserts,
the inserts are hexagonal cones,
the space between shell the tubes closest to the shell is covered by a strip of a plate,
the plate is welded to the upper ends of the tubes,
the shell to close the space between the upper ends of tubes and the shell,
the one or more intermediate tube sheet(s) is/are configured to prevent fluid flow between the chambers on the shell side,
the shell side of one or more of the chambers comprises baffles,
baffles are spaced apart in a successively closer manner along the flow of steam from the steam inlet to the inert gas outlet,
the first steam source provides a steam with a lower condensing temperature than the second steam source,
steam in fed different pressures into different shell side chambers,
the condensing temperature of the steam is relatively low in the chamber located closer to the upper head,
the condensing temperature of the steam is relatively high in the chamber located closer to the lower head,
the chamber located closer to the upper head is run colder than the chamber located closer to the lower head,
the steam flows in the direction from the bottom of each separate chamber to the top of each separate chamber,
a steam at atmospheric pressure having a temperature of about 100° C. is fed into the chamber located closer to the upper head,
a steam having an over pressure is fed into the chamber located closer to the lower head,
the steam fed into the chamber located closer to the lower head has an over pressure of 5 to 16 bar,
the steam fed into the chamber located closer to the lower head has a temperature of 150 to 200° C.,
the temperature of the process air is 50 to 70° C. when fed into the heat exchanger at the inlet,
the air is heated so that it is 100 to 180° C. at the outlet of the heat exchanger,
the solids are mechanical pulp, such as chemithermomechanical pulp (CTMP),
steam flows from the steam inlet to the inert gas outlet through a cross-sectional area that reduces in the direction of the flow of steam.

Considerable benefits may be gained with aid of the present proposed solution.

The risk of fouling and pressure drop are reduced by connecting two or more tubular heaters in series and constructing the heaters into a single unit, in which the shell side is divided into two or more chambers by means of intermediate tube sheets. The recirculated air flows in the tubes from top to bottom and the highest chamber has the lowest vapor pressure and the lowest chamber has the highest vapor pressure.

The pressure drop remains small, because the inlet and outlet losses to the tubes occur only once when compared to separate devices connected in series. The advantages of a built-in series connection are particularly apparent when drying heat-sensitive products, such as wood fibers, because solids particles can only accumulate in the blind areas of the top tube sheet. The upper tube sheet is in contact with the lowest pressure steam and thus has a lower temperature than other tube sheets. The fibers thus do not stain and do not adhere to the upper tube sheet, so that they can be easily removed by blowing air.

Blind areas of the upper tube sheet can be eliminated almost completely by means of shaped pieces, inserts, to be installed at the upper end of the tubes. The inserts can be pressed from the tubes, for example, so that the round lower end fits inside the heat exchanger tube and the conical upper end is formed into a hexagon. In this construction, the blind spots remain only between the outer shell and the outer tubes.

When using lower steam pressures it is possible to replace the traditional upper tube sheet with a tube sheet where the upper ends of the tubes are formed to have a hexagonal shape similar to the inserts. The hexagonal shaped upper ends of the tubes are attached to each other by for example welding to make a tight and pressure-resistant tube sheet.

### BRIEF DESCRIPTION OF THE DRAWINGS

FIG. 1 illustrates a cross-sectional view of a vertical tubular heat exchanger in accordance with at least some embodiments of the present invention;

FIG. 2 illustrates the top part of the vertical tubular heat exchanger in accordance with at least some embodiments of the present invention; and

FIG. 3 illustrates the top part of the vertical tubular heat exchanger in accordance with at least some embodiments of the present invention.

### EMBODIMENTS

### Definitions

As used herein, the term “about” refers to a value which is ±5% of the stated value.

As appears from above, it has been found that the heating process of air containing solids can be simplified and improved.

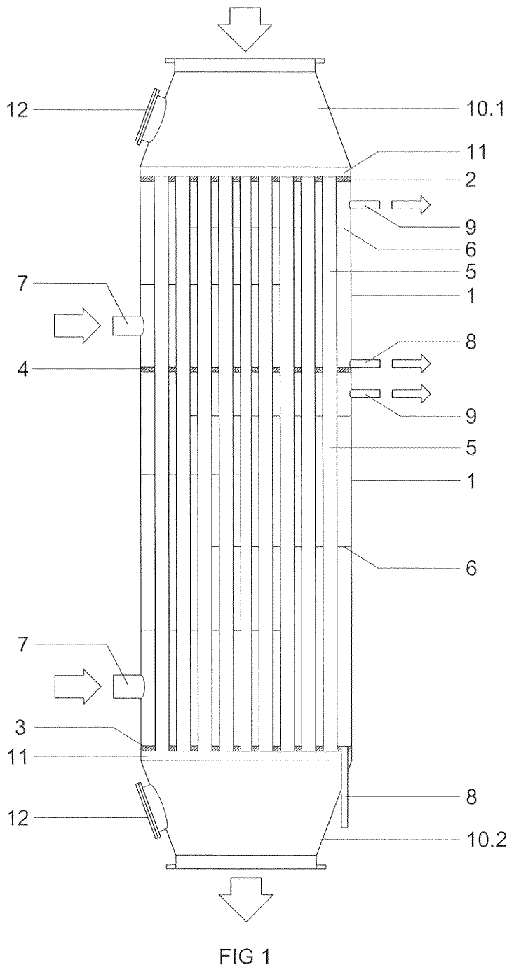

The invention will now be described in more detail with reference to the accompanying figures. FIG. 1 is a cross-sectional view of a vertical tubular heat exchanger in accordance with at least some embodiments of the present invention.

The heat exchanger comprises a shell side and a tube side. The heating steam flows on the shell side of the heat exchanger and the air to be heated flows on the tube side of the heat exchanger. The air to be heated comprises solids to be dried.

The shell side of the heat exchanger consists of a cylindrical shell 1, an upper tube sheet 2 and a lower tube sheet 3. The shell side is divided into two separate chambers by an intermediate tube sheet 4. The tube side consists of continuous tubes 5, which adhere at their upper end to the upper tube sheet 2 and the lower end to the lower tube sheet 3 and, when mangled, also to the intermediate tube sheet 4.

Inside the shell chambers, there are intervals of baffles 6 supporting the tubes 5 and directing the flow of steam. Steam is fed into the shell side through steam inlet connections 7. The steam condenses, which is then drained out of the shell side though the condensate outlet connections 8. Eventual inert gases are vented out of the shell side through the inert gas outlet connections 9. Each of the chambers have their own stream inlet 7, condensate outlet 8 and inert gas outlet 9 connections.

The baffles 6 may be spaced apart in a successively closer manner along the flow of steam. For example, examining the lower shell chamber of the illustrated exemplary heat exchanger, it may be seen that the shell chamber has four baffles 6 provided in a successive configuration. Starting from the steam inlet 7, the first baffle 6 has a first distance from the lower tube sheet 3, whereby the flow of steam entering via the steam inlet 7 flows through a relatively large first cross-sectional area formed between the first baffle 6 and the lower tube sheet 3. Observing the heat exchanger from bottom to top, the second baffle 6 has a second distance from the first baffle 6. The second distance is smaller than the first distance, whereby the steam flows through a relatively smaller second cross-sectional area formed between the first baffle 6 and the second baffle 6. Similarly, the third baffle 6 has a third distance from the second baffle 6. The third distance is smaller than the second distance, whereby the steam flows through a relatively smaller second cross-sectional area formed between the second baffle 6 and the third baffle 6. Finally, the fourth baffle 6 has a fourth distance from the third baffle 6. The fourth distance is smaller than the third distance, whereby the steam flows through a relatively smaller second cross-sectional area formed between the third baffle 6 and the intermediate tube sheet 4 and out via the inert gas outlet connection 9. As the baffles 6 are spaced apart in a successively closer manner along the flow of steam, the cross-sectional area of flow is reduced in the direction of the flow of steam. The same may hold true to other shell chambers in the heat exchanger, such as in upper shell chamber of the illustrated exemplary heat exchanger.

Steam inlet 7 and condensate outlet connections 8 of the shell chambers are attached to the lower parts of the shell chambers and the inert gas outlet connections 9 are attached to the upper parts of the shell chambers. Conical ends 10 on the tube side of the heat exchanger are attached by cylindrical parts 11 to the upper tube sheet 2 and lower tube sheet 3 of the heat exchanger. The conical ends 10 are provided with manholes 12 for maintenance purposes.

The air to be heated in the heat exchanger flows into the heat exchanger through the upper head 10.1 into the tubes 5 from top to bottom. As it flows the air is heated and finally exits the heat exchanger through the lower head 10.2

Different steams having different pressures can be used in the different shell chambers. Steam condensing at lower temperatures is used in the upper chamber, and steam condensing at higher temperatures is used in the lower chamber. The heating steam is introduced through the steam inlet connections 7 to the lower part of the chambers, from where they flow upwards under the control of the baffles 6 while condensing.

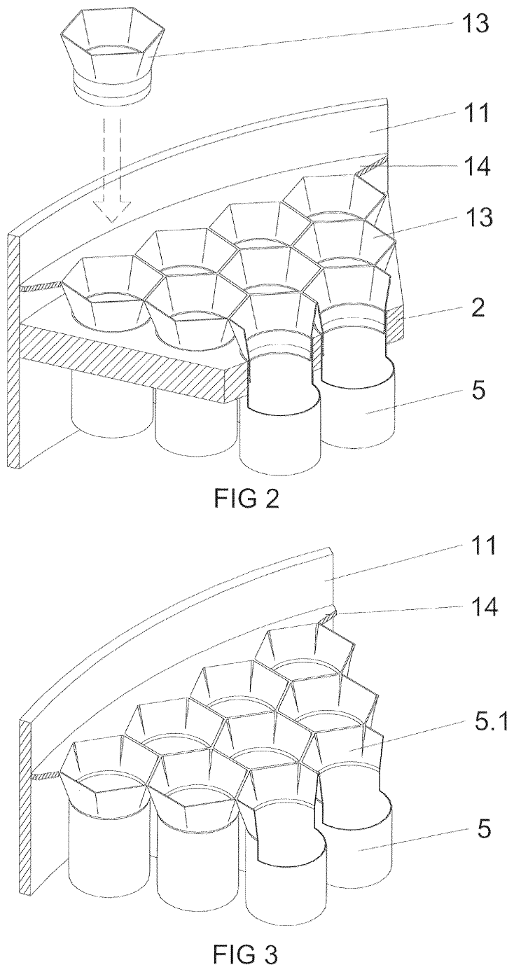

FIG. 2 illustrates the top part of the vertical tubular heat exchanger in accordance with at least some embodiments of the present invention. The upper tube sheet 2 of the tubular heat exchanger has hexagonal inserts 13 installed to the upper parts of the tubes 5. This prevents fouling and minimizes the pressure drop.

A strip of plate covers the space between the upper head 10.1 of the cylindrical part and the inserts 13. The surface temperature of the inserts is significantly less than the upper tube sheet 2, which is caused by the cooling effect of the air flowing into the heat exchanger.

FIG. 3 illustrates the top part of the vertical tubular heat exchanger in accordance with at least some embodiments of the present invention. The upper tube sheet 2 of the heat exchanger has been replaced by forming the upper ends of the tubes 5 into a hexagonal shape and a strip of plate 14 arranged between the outermost tubes and the cylindrical part 11 of the end 10.1 of the shell 1. The upper ends of the tubes and the strip of plate 14 are joint in a tight, pressure-resistant way, for example welded, to the shell 1.

According to an embodiment there is provided a vertical tubular heat exchanger having a tube side and shell side. The heat exchanger comprises a shell 1, an upper tube sheet 2, a lower tube sheet 3, a plurality of straight tube 5, an upper head 10.1 and a lower head 10.2. The upper head 10.1 is at the upper end of the shell 1 and the lower head 10.2 is at the lower end of the shell. The shell side of the heat exchanger is divided into two or more separate shell side chambers by one or more intermediate tube sheet 4. The thermal design of the shell side chambers is done separately. Accordingly, the chambers are likely to define different volumes. One may, however, foresee an embodiment, where the chambers enclose similar volumes.

According to an embodiment the shell side has connections for steam inlet 7, condensate outlet 8 and inert gas outlet 9. The connections for steam inlet 7 and condensate outlet 8 are located in the lower part of the shell side chambers and the connection for inert gas outlet 9 is located at the upper part of the shell side chambers. Each chamber is equipped with one of each connection. Steam is fed into the chambers through the steam inlet connections 7. The condensed steam is drained out of the chambers through the condensate outlet connections 8. The steam that is not condensed is vented out of the chambers through the inert gas outlet connections 9.

The height of the heat exchanger may be in the range of 10 to 30 meters, such as 17-23 meters, particularly about 20 meters.

The diameter of the heat exchanger may be in the range of one to five meters, such as 2.5-3.5 meters, particularly about 3 meters.

According to an embodiment, the heat exchanger further comprises tubes 5 surrounded by the shell 1.

The number of tubes 5 in the heat exchanger may be between 500 to 5000, such as about 2500.

The tubes 5 may have a diameter in the range of 30 to 80 mm. The wall thickness of the tube 5 may be in the range of 1 to 2 mm.

The tubes 5 may have a length in the range of 5 to 15 m, such as 12 m.

According to an embodiment, the tubes 5 have an upper end at the upper end of the shell. The upper ends may be provided with inserts 13. The inserts 13 may feature a funneled shape, such as a conical shape, particularly a hexagonal truncated cone.

According to an embodiment, the upper tube sheet 2 envelops the upper ends of the tubes 5. The inserts 13 may be inserted into said upper ends of the tubes 5 so as to extend from the tubes 5. The space between shell 1 the tubes 5 closest to the shell 1 may be covered by a strip of plate 14, which may be welded to the upper ends of the inserts 13 and the shell 1 to close the space between the upper ends of inserts 13 and the shell 1. If no inserts are used, a similar strip of a plate 14 may close off a space left between the shell 1 and the upper ends of the exposed tubes 5.

According to an embodiment there is provided a system comprising the heat exchanger as described above, a first steam source is connected to the chamber located closer to the upper head 10.1 and a second steam source is connected to the chamber located closer to the lower head 10.2. The steam sources are connected to the steam connections 7 of each chamber.

According to an embodiment the first steam source has a lower condensing temperature than the second steam source.

According to an embodiment the steams configured to heat the different chambers of the shell side of the heat exchanger have different condensing temperatures, for example so that the heating steam condensing at the chamber closer the first end of the shell side has the lowest condensing temperature and the heating steam condensing at the chamber closer to the second end of the shell side has the highest condensing temperature.

According to an embodiment, there is provided a method for heating air containing solids comprising:
feeding process air, which contains moist solids, into the heat exchanger according to the above description; and
feeding steam to the first and second chambers.

The process air flows in the direction from the air inlet at top of the heat exchanger to the air outlet at the bottom of the heat exchanger.

According to an embodiment, the chamber located closer to the upper head 10.1 is colder than chamber located closer to the lower head 10.2.

According to an embodiment, the steam flows in the direction from the bottom of each separate chamber to the top of each separate chamber.

According to an embodiment a steam at atmospheric pressure having a temperature of in the range of about 100° C. is fed into the chamber located closer to the upper head (10.1). A steam having an over pressure in the range of about 5 to 16, such as 10 bar, and a temperature in the range of about 150 to 200° C., such as about 180° C., is fed into the chamber located closer to the lower head (10.2).

The temperature of the inlet air may be in the range of about 50 to 70° C., such as 60° C. The temperature of the outlet air may be in the range of about 100 to 180° C. at the outlet of the heat exchanger.

According to an embodiment, the air containing the solids is heated by the steam flowing on the shell side of the heat exchanger.

According to an embodiment, the solids are mechanical pulp, such as chemithermomechanical pulp (CTMP).

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The presently disclosed air heater for heating air containing solids and method for heating air containing solids can be used in pneumatic particle dryers. In particular, it can be used in drying mechanical pulp, such as chemithermomechanial pulp.

### ACRONYMS LIST

CTMP Chemithermomechanial pulp

### REFERENCE SIGNS LIST

1 cylindrical shell
2 upper tube sheet
3 lower tube sheet
4 intermediate tube sheet
5 tube
6 baffle
7 steam inlet connection
8 condensate outlet connection
9 inert gas outlet connection
10 conical end
10.1 upper head
10.2 lower head
11 cylindrical part
12 manhole
13 insert
14 strip of plate

1. A system for heating air containing solids, the system comprising a vertical tubular heat exchanger for heating air containing solids, the heat exchanger a tube side and a shell side and comprising:
a shell,
an upper tube sheet,
a lower tube sheet,
a plurality of straight tubes,
an upper head
a lower head, and
one or more intermediate tube sheet(s) which divide(s) the shell side of the heat exchanger into two or more separate shell side chambers,
wherein:
the shell side has connections for steam inlet condensate outlet and inert gas outlet,
the system comprises a first steam source connected to the steam inlet of a chamber located closer to the upper head, and wherein
the system comprises a second steam source connected to the steam inlet of a chamber located closer to the lower head,
wherein:
the connections for steam inlet and condensate outlet are located in the lower part of the shell side chambers and the connection for inert gas outlet is located at the upper part of the shell side chambers,
the tubes extend continuously between the upper tube sheet and the lower tube sheet, and in that
the first steam source is configured to provide a steam with a lower condensing temperature than the second steam source, wherein the upper tube sheet is in contact with the steam with the lower condensing temperature.

2. The system according to claim 1, wherein the upper ends of the tubes are provided with inserts as extensions of the tubes.

3. The system according to claim 2, wherein the upper tube sheet contacts the upper ends of the tubes, and the space between the shell and the inserts closest to the shell is covered by a strip of plate to close the space between the inserts and the shell.

4. The system according to claim 1, wherein the one or more intermediate tube sheet(s) is/are configured to prevent fluid flow between the chambers on the shell side.

5. The system according to claim 1, wherein the shell side of one or more of the chambers comprises baffles, which are spaced apart in a successively closer manner along the flow of steam from the steam inlet to the inert gas outlet.

6. A method for heating air containing solids comprising:
feeding process air, which contains moist solids, into tubes of the system according to claim 1, wherein the process air flows in the direction from the air inlet at top of the heat exchanger to the air outlet at the bottom of the heat exchanger, and
feeding steam to the two or more separate shell side chambers, wherein steam with a relatively low condensing temperature is fed to the chamber located closer to the upper head and steam with a relatively high condensing temperature is fed to the chamber located closer to the lower head.

7. The method according to claim 6, wherein feeding steam in different pressures into different shell side chambers.

8. The method according to claim 6, wherein the chamber located closer to the upper head is run colder than the chamber located closer to the lower head.

9. The method according to claim 6, wherein the steam flows in the direction from the bottom of each separate chamber to the top of each separate chamber.

10. The method according to claim 6, wherein a steam at atmospheric pressure having a temperature of about 100° C. is fed into the chamber located closer to the upper head and a steam having an over pressure and a temperature in the range of more than 100 and at most 180° C. is fed into the chamber located closer to the lower head.

11. The method according to claim 6, wherein the temperature of the process air is in the range of about 50 to 70° C. when fed into the heat exchanger at the inlet and the air is heated so that it is about 100 to 180° C. at the outlet of the heat exchanger.

12. The method according to claim 6, wherein the solids are mechanical pulp, such as chemithermomechanical pulp (CTMP).

13. The method according to claim 6, wherein steam flows from the steam inlet to the inert gas outlet through a cross-sectional area that reduces in the direction of the flow of steam.
